(19) United States
(12) Patent Application Publication
(10) Pub. No.: US 2006/0024520 A1
(43) Pub. Date: Feb. 2, 2006

(54) Permeable polypropylene film

(76) Inventors: Dan-Cheng Kong, Fairport, NY (US); Etienne R.H. Lernoux, Pittsford, NY (US); Robert M. Sheppard, Victor, NY (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/114,671

(22) Filed: Apr. 26, 2005

Related U.S. Application Data
(63) Continuation-in-part of application No. 10/910,146, filed on Aug. 2, 2004.

(51) Int. Cl. B32B 27/08

(52) U.S. Cl. 428/517

(57) ABSTRACT

A permeable, propylene-containing film structure including a core layer containing a propylene polymer matrix that has been cavitated by a two-component cavitation system, wherein the first component of the two-component cavitation system is a beta-nucleating agent to produce the beta-crystalline form of polypropylene and the second component is a filler. The film structure also includes first and second thermoplastic skin layers on either side of the core layer, respectively. A method of manufacturing a permeable propylene-containing film structure, including: forming a melt containing a propylene polymer, a beta-nucleating agent and a filler; cooling the melt to form a film layer; and stretching the film layer. The film structure has a water vapor transmission rate greater than 300 g/m²/day and a Gurley air permeability less than 3,000 s/10 cc.

This application is a continuation-in-part of U.S. patent application Ser. No. 10/910,146, filed on Aug. 2, 2004, now pending.

### BACKGROUND OF THE INVENTION

The invention relates to a permeable, propylene-containing film structure. In particular, the invention relates to a film structure that is highly permeable to both gas and water vapor, at least the core layer of the film structure having been cavitated via beta-nucleated (beta-crystalline) orientation in the presence of a filler. The film structure also has uniform opacity, low density, and enhanced stiffness. The invention takes advantage of a previously unknown synergy between a beta-nucleating agent and a filler. The permeable film structure is especially suited for labeling applications.

The market for polymer films continues to expand. One area of growth is in the food and beverage industry. Polymer films are increasingly being used as labels in the food and beverage industry, in part due to their printability and their ability to conform and adhere to the surface of a food package or beverage container. The preferred label, however, is opaque and/or colored, e.g., a white opaque label. Polymer films, on the other hand, especially polyolefin films, are inherently clear and colorless. Therefore, polymer films to be used as labels are generally modified to render them opaque and/or colored.

A variety of techniques are known to modify a polymer film and render it opaque and/or colored.

For example, it is well known in the art to include certain organic or inorganic cavitating agents in one or more layers of a polymer film. The organic cavitating agent may be a polyester, such as polyethylene terephthalate (PET) or polybutylene terephthalate (PBT). The inorganic cavitating agent may be calcium carbonate (CaCO₃). The presence of the cavitating agent in a layer of the film during orientation of the film induces voids in the polymeric material comprising the layer of the film. The voids scatter light thereby causing the film to be opaque.

U.S. Pat. No. 4,632,869 to Park, et al., discloses an opaque, biaxially oriented film structure containing a voided polymer matrix layer, in which the voids contain spherical void-initiating particles of polybutylene terephthalate (PBT). The structure may also include thermoplastic skin layers, and the individual layers may include pigments, such as TiO₂ or colored oxides.

However, the use of CaCO₃— or PBT-type cavitating agents to induce voids in a polymer film, as proposed by U.S. '869 and others like it, is an example of a single component cavitation method. Single component cavitation of this type tends to yield relatively large average pore sizes. As a result, the mechanical properties of the film suffer, leading to inferior resistance to permanent deformation, e.g., label wrinkling, label buckling, or label shrinkage, when the film is subjected to bending and creasing stresses.

In addition, single component cavitation of this type tends to yield a non-uniform void distribution due to dispersion problems with the filler. Furthermore, the cavitated films produced from single component cavitation of this type tend to have a density falling within the range of from greater than 0.45 g/cm³ to 0.90 g/cm³.

It is also known in the art to induce voids in a film layer containing polypropylene by including therein a beta-crystalline nucleating agent. The voids formed by this type of single component cavitation method tend to have a decreased average pore size.

There are three types of crystalline forms for polypropylene—alpha, beta, and gamma. The alpha-crystalline form of polypropylene has a monoclinic crystal structure. The beta-crystalline form of polypropylene has a hexagonal crystal structure. The gamma-crystalline form of polypropylene has a triclinic crystal structure. The gamma-crystalline form of polypropylene has the highest density, while the beta-crystalline form has the lowest density.

However, the gamma-crystalline form of polypropylene only grows under high pressure. In typical film processing conditions, the gamma-crystalline form is not observed. And between the alpha-crystalline and beta-crystalline forms, the alpha-crystalline form is the more stable crystalline form. Under typical film processing conditions, the majority of polypropylene will be the alpha-crystalline form. Therefore, a beta-crystalline nucleating agent is required in order to produce a significant amount of the beta-crystalline form of polypropylene during melt crystallization.

EP 0 865 909 of Davidson et al. discloses biaxially oriented, heat-shrinkable polyolefin films for use as labels, having a layer of a polypropylene-based resin with microvoids therein. The microvoids are formed by stretching a web containing the beta-crystalline form of polypropylene.

EP 0 865 910 and EP 0 865 912, both of Davidson et al., disclose biaxially oriented polyolefin opaque films having a thickness of not more than 50 μm and having a layer of a polypropylene-based resin with microvoids therein. The microvoids are formed by stretching a web containing the beta-crystalline form of polypropylene at an area stretch ratio of at least 15:1.

EP 0 865 911 of Davidson et al. discloses biaxially oriented polyolefin films containing a heat seal layer and a layer having microvoids formed therein by stretching the polypropylene-based resin of the layer, which contains the beta-crystalline form of polypropylene. The heat seal becomes transparent upon heating.

EP 0 865 913 of Davidson et al. discloses biaxially oriented, heat-shrinkable polyolefin films having a layer of a polypropylene-based resin with microvoids therein. The microvoids have been formed by stretching a web containing the beta-crystalline form of polypropylene. The film has a shrinkage after 10 minutes at 130° C. of at least 10% in at least one direction.

EP 0 865 914 of Davidson et al. discloses biaxially oriented, high gloss polyolefin films having a layer of a polypropylene-based resin with microvoids therein and at least one olefin copolymer outer layer thereon. The microvoids have been formed by stretching a web containing the beta-crystalline form of polypropylene.

U.S. Pat. No. 6,444,301 to Davidson, et al. discloses polymeric films including a layer of propylene resin having microvoids therein, the microvoids having been formed by stretching a web containing the beta-form of polypropylene.

U.S. Pat. No. 5,594,070 to Jacoby, et al. discloses oriented microporous films prepared from polyolefin resin compositions comprising an ethylene-propylene block copolymer having an ethylene content of about 10 to about 50 wt. %, a propylene homopolymer or random propylene copolymer having up to about 10 wt., % of a comonomer of ethylene or an α-olefin of 4 to 8 carbon atoms, and components selected from a low molecular weight polypropylene, a beta-spherulite nucleating agent and an inorganic filler. The microporous films are said to have improved breathability, strength, toughness and break elongation. However, the films of Jacoby have a tendency to exhibit pink color when red dye (beta-spherulite nucleating agent) concentration is higher than 50 ppm. If the concentration of red dye (beta-spherulite nucleating agent) is lower than 50 ppm, then it is difficult to obtain consistent opacity due to poor dispersion uniformity.

However, films cavitated using only a beta-crystalline nucleating agent, such as films from the various Davidson publications noted above, are single component cavitated films.

The polymer films market is also expanding due to growth in the permeable films segment.

However, permeable polyolefin films that presently are commercially available include those made with an embossable polyolefin loaded with a high concentration of a filler, polyolefin films with high concentrations of a filler and low MD orientation, polyolefin films which are compounded with plasticizer and later have the plasticizer extracted therefrom, and spun-bond fibers. These types of permeable films are either expensive or difficult to process.

For example, U.S. Pat. No. 4,777,073 to Sheth discloses a breathable polyolefin film prepared by melt embossing a highly filled polyolefin film to impose a pattern of different film thickness therein and by stretching the melt embossed film to impart greater permeability in the areas of reduced thickness in comparison to the areas of greater thickness.

U.S. Pat. No. 6,002,064 to Kobylivker, et al. discloses a stretch-thinned polymeric film formed from a mixture of a polymer matrix including a low crystallinity propylene polymer having not more than about 30% crystallinity, with a particulate filler.

U.S. Pat. No. 6,045,900 to Haffner, et al. discloses a breathable barrier laminate having a first film layer comprising a microporous breathable barrier film; a second film layer comprising a breathable filled film which comprises about 50% to about 70% by weight of a filler and an amorphous polymer such as an elastomeric ethylene polymer having a density less than 0.89 g/cm³; and a third fibrous layer comprising a breathable outer layer, such as a nonwoven web of spunbonded fibers. The multiple layers are thermally laminated wherein the laminate has a peel strength in excess of 200 grams and a WVTR in excess of 300 g/m²/day.

U.S. Pat. No. 6,106,956 to Heyn, et al. discloses a polymer film comprising at least first and second contiguous and coextruded portions, wherein the first portion is extruded from a first polymer composition containing a filler material in an amount sufficient to increase the water vapor permeability of the first portion relative to the second portion, and the second portion is extruded from a second polymer composition such that a tensile strength of the second portion is greater than the tensile strength of the first portion.

Finally, U.S. Pat. No. 6,534,166 to Pip, et al. discloses films having particular water vapor transmission rates (WVTR) produced by methods including adherently superimposing at least one layer of a WVTR-controlling material to a base layer including a polyethylene and a cavitating agent, and subsequently biaxially orienting the composite polyethylene sheet to yield a film having the desired WVTR. The base layer has a porous microstructure and a WVTR substantially higher than the desired WVTR.

### SUMMARY OF THE INVENTION

It is an object of the invention to provide a film structure that is highly permeable to both gas and water vapor.

It is also an object of the invention to provide a permeable film structure, which has uniform opacity, a low density and improved mechanical properties, that is economically advantageous.

It is additionally an object of the invention to provide a permeable film structure, which has uniform opacity, a low density and improved mechanical properties, that is particularly suited for labeling applications.

There is provided a permeable film structure containing at least three layers, the core layer comprising a propylene polymer matrix that has been cavitated by a two-component cavitation system, wherein the first component of the two-component cavitation system is a beta-nucleating agent to produce the beta-crystalline form of polypropylene, and the second component is a filler.

In preferred embodiments, there is provided a film structure that is highly permeable to both gas and water-vapor, comprising: a core layer comprising a propylene polymer, a beta-nucleating agent, and a filler; a first skin layer on a first side of the core layer, the first skin layer comprising a propylene polymer; and a second skin layer on a second side of the core layer, the second skin layer comprising a propylene polymer; and wherein the film structure is opaque and has been biaxially oriented. In particularly preferred embodiments, each of the core layer, first skin layer, and second skin layer is cavitated.

There is also provided a label comprising the permeable film structure containing at least three layers, the core layer comprising a propylene polymer matrix that has been cavitated by a two-component cavitation system, wherein the first component of the two-component cavitation system is a beta-nucleating agent to produce the beta-crystalline form of polypropylene, and the second component is a filler.

There is furthermore provided a method of manufacturing a permeable film structure, comprising: forming a melt comprising a propylene polymer, a beta-nucleating agent and a filler; cooling the melt to form a film layer; and stretching the film layer to form voids therein.

The invention takes advantage of a previously unknown synergy between the beta-nucleating agent and the filler, which, when combined with a tailored combination of the respective amounts of the propylene polymer beta-nucleating agent and the filler in the core layer, as well as the selection of first and second skin layers, provides a film structure that is highly permeable to both gas and water vapor, insofar as it has a water vapor transmission rate greater than 300 g/m²/day and a Gurley air permeability less than 3,000 s/10 cc.

### DETAILED DESCRIPTION OF THE INVENTION

“Core layer” as used herein refers to the only layer of a monolayered film or the thickest layer of a multilayered film. In general, the core layer of a multilayer structure will usually be the innermost, central layer of the structure.

It will be understood that when a layer is referred to as being “directly on” another layer, no intervening layers are present. On the other hand, when a layer is referred to as being “on” another layer, intervening layers may or may not be present.

“A filler” as used herein encompasses both the use of a single filler or any combination of fillers.

The permeable film structure comprises a core layer.

The core layer comprises a polymeric matrix comprising a propylene polymer. The term “propylene polymer” as used herein includes homopolymers as well as copolymers of propylene, wherein a copolymer not only includes polymers of propylene and another monomer, but also terpolymers, etc. Preferably, however, the propylene polymer is a propylene homopolymer.

The propylene polymer of the core layer preferably has an isotacticity ranging from about 80 to 100%, preferably greater than 84%, most preferably from about 85 to 99%, as measured by ¹³C NMR spectroscopy using meso pentads. A mixture of isotactic propylene polymers may be used. Preferably, the mixture comprises at least two propylene polymers having different m-pentads. Preferably, the difference between m-pentads is at least 1%. Furthermore, the propylene polymer of the core layer preferably has a melt index ranging from about 2 to about 10 g/10 minutes, most preferably from about 3 to about 6 g/10 minutes, as measured according to ASTM D1238 at 190° C. under a load of 5 lbs.

Commercially available propylene polymers for the core layer include 3371, which is an isotactic polypropylene homopolymer sold by Total Petrochemicals USA, Inc., and PP4612E2, an isotactic propylene homopolymer, available from ExxonMobil Chemical Company (Houston, Tex.).

The core layer also comprises a beta-crystalline nucleating agent. Any beta-crystalline nucleating agent (“beta-nucleating agent” or “beta-nucleator”) may be used.

U.S. Pat. No. 4,386,129 to Jacoby and U.S. Pat. No. 4,975,469 to Jacoby disclose processes of forming a film containing nucleating agents to produce beta-form spherulites and then selectively extracting the beta-spherulites. Both Jacoby patents disclose quinacridone compounds, bisodium salts of o-phthalic acids, aluminum salts of 6-quinizarin sulfonic acid and isophthalic and terephthalic acids as beta-nucleating agents.

U.S. Pat. No. 5,681,922 to Wolfschwenger, et al. discloses the use of dicarboxylic acid salts of metals of the second main group of the Periodic Table as beta-nucleating agents.

A two-component beta-nucleator may be used as the beta-nucleating agent of the invention. For example, U.S. Pat. No. 5,231,126 to Shi, et al. discloses the use of a mixture of a dibasic organic acid and an oxide, hydroxide or salt of a metal of group IIA of the Periodic Table. A two-component beta-nucleator is not to be confused with the two-component cavitation method of the invention. A two-component beta-nucleator still makes up only one component of the present two-component cavitation method for producing the cavitated opaque polymer films of the invention.

U.S. Pat. Nos. 5,491,188; 6,235,823; and EP 0 632 095; each of Ikeda, et al., disclose the use of certain types of amide compounds as beta-nucleators.

U.S. Pat. No. 6,005,034 to Hayashida, et al. discloses various types of beta-nucleators.

U.S. Pat. Nos. 4,386,129; 4,975,469; 5,681,922; 5,231,126; 5,491,188; 6,235,823; and 6,005,034; as well as EP 0632095, are herein incorporated by reference to the extent not inconsistent with the disclosure herein.

Preferably, the beta-nucleating agent is a two-component beta-nucleator formed by the mixing of Components A and B. Component A is an organic dibasic acid, such as pimelic acid, azelaic acid, o-phthalic acid, terephthalic and isophthalic acid and the like. Component B is an oxide, hydroxide or an acid salt of a Group II metal, e.g., magnesium, calcium, strontium and barium. The acid salt of Component B may come from inorganic or organic acid such as carbonate, stearate, etc. Component B may also be one of the additives of polypropylene that already is present in the polypropylene material. The proportion of component A may be in the range of 0.0001-5% by weight, based on the total weight of polypropylene, most preferably 0.0°-1 wt %, whereas the proportion of component B is 0.0002-5% by weight, based on the total weight of polypropylene, most preferably 0.05-1%, during mixing.

Preferably, the beta-nucleating agent is not a red dye.

Preferably, the propylene polymer and beta-nucleating agent are brought together to form the core layer via a masterbatch.

For example, in some embodiments, the core layer may comprise BEPOL 022SP, a masterbatch of isotactic propylene homopolymer and beta-nucleating agent, available from Sunoco Chemicals. In other embodiments, the core layer may comprise an impact propylene copolymer masterbatch with a beta-crystal nucleator of polypropylene or the core layer may comprise an impact propylene copolymer masterbatch with a beta-crystal nucleator of polypropylene and an isotactic polypropylene. In still other embodiments, the core layer may comprise: an (isotactic propylene)-ethylene heterophasic copolymer masterbatch with a beta-crystal nucleator of polypropylene and an isotactic polypropylene; an impact polypropylene masterbatch with a beta-crystal nucleator of polypropylene and a metallocene isotactic polypropylene; or an (isotactic propylene)-ethylene heterophasic copolymer, ethylene-propylene-ethylidene norbornene elastomer, isotactic polypropylene masterbatch with a beta-crystal nucleator of polypropylene and an isotactic polypropylene that has a different m-pentad than the isotactic polypropylene in the isotactic polypropylene masterbatch.

One type of impact copolymer which may be used in the invention comprises a polymer matrix with a dispersed rubbery copolymer phase. The matrix is a homopolymer or random copolymer matrix. The rubbery copolymer phase is a reactor blend of an amorphous rubber, a rubber-like polymer which is normally an ethylene-propylene copolymer (rubber), and a semicrystalline ethylene copolymer.

By mixing the propylene polymer of the core layer, which predominantly contains the alpha-crystalline form of polypropylene, with the beta-nucleating agent of the core layer, high concentrations of the beta-crystalline form of polypropylene are induced after the melting and subsequent cooling steps of the film-making process. The beta-crystalline form of polypropylene has a lower melting point and a lower density than the common alpha-crystalline form of polypropylene.

The core layer furthermore comprises a filler. Preferably, the filler is an inorganic filler. Most preferably, the filler is selected from the group consisting of calcium carbonate (CaCO₃), barium carbonate (BaCO₃), clay, talc, silica, mica, titanium dioxide (TiO₂) and mixtures thereof.

Although in broader embodiments the filler of the invention encompasses an organic filler, preferably the filler is not an organic filler. Organic fillers tend to plate-out, which results in manufacturing downtime. Also, the cavitation quality from the use of organic fillers is sensitive to the viscosity change from the polypropylene reclaims and output rate variations.

The amount of a filler to be included in the core layer may range from 1 to 50 wt %, based on the total weight of the core layer. Preferably, the core layer contains from 5 to 35 wt % of a filler, most preferably from 5 to 25 wt %, based on the total weight of the core layer.

The amount of beta-nucleator to be included in the core layer should be enough to obtain the desired degree of void formation upon stretching. The amount of beta-nucleator may also be used to control the degree of opacity. Preferred amounts of beta-nucleator are from 50 ppm to 1,000 ppm based on the amount of propylene polymer in the core layer, more preferably from 50 to 500 ppm, more preferably from 50 to 300 ppm, and most preferably from 100 to 200 ppm.

Generally, the remainder of the core layer is made up of the propylene polymer(s) mentioned above, after the filler, beta-nucleator, and any optional additives have been taken into account.

The core layer is typically the thickest layer of the film structure. Preferably, the core layer thickness is at least 70% of the whole film thickness.

The permeable film structures of the invention may be multilayer film structures wherein another layer or layers besides the core layer has been cavitated. In preferred embodiments, at least one other layer besides the core layer of the permeable film structure is cavitated. More preferably, at least two other layers besides the core layer of the permeable film structure are cavitated. Most preferably, each layer of the permeable film structure is cavitated. In particular, the optimum combination of low density, low light transmission and high permeability to both gas and water vapor is attained when each layer of the permeable film structure is cavitated.

The other cavitated layer(s) of the permeable film structure may be cavitated via the two-component cavitation method of the invention. For example, another layer(s) of a multilayer film structure according to this invention may comprise each of the same cavitating components as the core layer.

Alternatively, the other cavitated layer(s) of the permeable film structure is cavitated without using the two-component cavitation method of the invention. For example, the other cavitated layer(s) of the permeable film structure may be cavitated by use of a single component cavitation method, e.g., a filler only or a beta-nucleator only. Indeed, the other cavitated layer(s) of the permeable film structure may be cavitated by any manner known in the art, including microperforation of the layer or embossing the layer.

The permeable film structures of the invention comprise a first skin layer on one side of the core layer. The first skin layer may be provided on or directly on a side of the core layer. The first skin layer may be cavitated by the two-component cavitation method of the invention or by any manner known in the art.

In general, the first skin layer may comprise a polymeric matrix comprising any of the film-forming thermoplastic polymers. Examples of suitable film-forming thermoplastic polymers include the polyolefins, such as propylene polymers and ethylene polymers.

In preferred embodiments, the first skin layer comprises a propylene polymer selected from the group consisting of isotactic propylene homopolymer, syndiotactic propylene homopolymer, isotactic propylene impact copolymer, and syndiotactic propylene impact copolymer. The propylene homopolymer and propylene impact copolymer may contain a beta-nucleating agent. For example, the impact copolymer may be TI-4040-G, an impact propylene copolymer available from Sunoco Chemicals. TI-4040-G contains 17% ethylene-propylene rubber content. The ethylene-propylene rubber content of TI-4040-G can, upon stretching, cause cavitation of the layer comprising the TI-4040-G.

In other embodiments, the first skin layer will be a sealable skin layer, such as a heat-sealable skin layer. For example, the first skin layer may comprise propylene-ethylene copolymer, propylene-ethylene-butene-1 terpolymer (such as XPM7510, an ethylene-propylene-butene-1 terpolymer, available from Chisso Company, Japan), propylene-a-olefin copolymer, or metallocene-catalyzed ethylene-α-olefin copolymer.

In still other embodiments, the first skin layer is a sealable skin layer comprising a polymer selected from the group consisting of an an (isotactic propylene)-α-olefin copolymer, a (syndiotactic propylene)-α-olefin copolymer, an ethylene-vinyl acetate copolymer (EVA), an ethylene-methacrylic acid copolymer (EMA), an ethylene-acrylic acid copolymer (EAA), an ethylene-methylacrylate-acrylic acid terpolymer (EMAAA), an ethylene-alkyl acrylate copolymer, an ionomer such as ethylene-alkyl acrylate-acrylic acid Zn salt or Na salt, a metallocene-catalyzed plastomer, a very low density polyethylene (VLDPE), for example, having a density of 0.89 to 0.915 g/cc, an ethylene-(methyl acrylate)-(glycidyl methacrylate) terpolymer, and an ethylene-(glycidyl methacrylate) copolymer.

The first skin layer may also comprise a mixture of any of the foregoing polymers.

As mentioned, the first skin layer may be provided directly on a side of the core layer or on a side of the core layer with one or more intermediate layers therebetween.

An intermediate, or tie layer of the invention may comprise a polymeric matrix comprising any of the film-forming polymers. Suitable film-forming polymers for forming the polymeric matrix of the optional intermediate layer(s) include polyolefins, such as polypropylene, syndiotactic polypropylene, polypropylene copolymers, low density polyethylene (LDPE), linear low density polyethylene (LLDPE), medium density polyethylene (MDPE), high density polyethylene (HDPE), ethylene copolymers, nylons, polymers grafted with functional groups, blends of these, etc. For example, an intermediate layer may comprise a polyolefin grafted with a functional group, such as ADMER 1179, a maleic anhydride-grafted polypropylene available from Mitsui Petrochemical Industries Ltd. (Tokyo, Japan). The intermediate, or tie layer may be cavitated by the two-component cavitation method of the invention or by any manner known in the art.

Permeable film structures of the invention further comprise a second skin layer on a side of the core layer opposite the first skin layer.

The film-forming material for the second skin layer may be independently selected from the same film-forming materials noted above for the first skin layer.

As with the first skin layer, the second skin layer may be provided directly on the side of the core layer or on the side of the core layer with one or more intermediate layers therebetween. The intermediate layer between the core layer and second skin layer may comprise a polymeric matrix comprising any of the film-forming polymers. For example, the film-forming material for an intermediate layer between the core layer and second skin layer may be independently selected from the same film-forming materials noted above for an intermediate layer between the core layer and first skin layer.

Both the second skin layer and any intermediate, or tie layer between it and the core layer may be cavitated by the two-component cavitation method of the invention or by any manner known in the art.

One or both outer surfaces of the overall film structure may be surface treated. In the case of a monolayer structure, the outer surfaces of the structure would simply be the outer surfaces of the core layer. If the structure consists of a core layer and first skin layer, the outer surfaces would be the surface of the first skin layer opposite the core layer and the surface of the core layer opposite the first skin layer. If the structure contains a core layer and at least first and second skin layers, the outer surfaces would be the surfaces of the first and second skin layers that are respectively opposite the core layer.

The surface treatment may be effected by any of various techniques, including, for example, flame treatment, corona treatment, and plasma treatment. In certain embodiments, the outer surface or surfaces may even be metallized. Metallization can be effected by vacuum deposition, or any other metallization technique, such as electroplating or sputtering. The metal may be aluminum, or any other metal capable of being vacuum deposited, electroplated, or sputtered, for example, gold, silver, zinc, copper, or iron.

One or both outer surfaces of the overall film structure may be coated with a coating, such as a primer coating, e.g., a polyvinylidene chloride (PVdC), acrylic, or silicon oxide (SiOₓ) coating, a water-based coating, or a coating comprising inorganic particles, such as clay, calcium carbonate, or titanium oxide, dispersed in a binder, such as an iminated butyl acrylate copolymer. Coatings may be used to provide advantages such as enhanced gloss and enhanced compatibility with manufacturing processes and machinery. In certain embodiments, priming the first skin layer can render it more receptive to printing.

In order to modify or enhance certain properties of the overall film structure, it is possible for one or more of the layers to contain dispersed within their respective matrices appropriate additives in effective amounts. Preferred additives include anti-blocks, anti-static agents, anti-oxidants, anti-condensing agents, co-efficient of friction (COF) modifiers (slip agents), processing aids, colorants, clarifiers, foaming agents, flame retardants, photodegradable agents, UV sensitizers or UV blocking agents, crosslinking agents, ionomers and any other additives known to those skilled in the art.

For example, in certain embodiments, it may be desirable to include a coloring agent, such as a pigment or dye, in one or more of the layers, including the first skin layer or the tie layer between the core layer and first skin layer.

As another example, in certain embodiments, and especially certain label embodiments, the polymer matrix of a skin layer may include dispersed therein one or more anti-block agents to prevent “grabbing” of the label on machine surfaces, one or more slip agents to provide better slip on heated metal surfaces, and/or one or more anti-static agents to maximize sheetability. Specific examples of anti-block agents include coated silica, uncoated silica and crosslinked silicone. Specific examples of slip agents include silicone oils. Specific examples of anti-static agents include alkali metal sulfonates, tertiary amines and the like.

The invention provides permeable film structures that have been tailored for label applications. A preferred label structure comprises a core layer comprising a polymeric matrix comprising a propylene polymer, a beta-nucleating agent, and a filler, and first and second skin layers. The first and second skin layers may be provided on or directly on the respective sides of the core layer.

Preferably, a label according to the invention will comprise an adhesive provided on an outer surface of the first or second skin layer. The type of adhesive to be employed is not particularly limited. As an example, the adhesive may be a water-based adhesive, such as a cold glue adhesive or a polyvinylidene chloride latex. Cold glue adhesives are natural or synthetic adhesives, such as HENKEL 7302, available from Henkel Adhesives, or OC 363-20, available from O.C. Adhesives Corp. As another example, the adhesive may be a pressure-sensitive adhesive. Adhesives suitable for labels are well-known in the art.

Alternatively, a label according to the invention can be an in-mold label used in the making of hollow blown articles such as containers. Methods of manufacturing hollow blown articles which include the use of an in-mold label are well-known in the art, and any in-mold labeling method may be used to apply an in-mold label according to the invention onto a container. As just one example, reference is made to U.S. Pat. No. 5,855,838, which is herein incorporated by reference to the extent not inconsistent with the disclosure herein.

There is also provided a method of manufacturing a permeable film structure. For example, a melt(s) corresponding to the individual layer(s) of the film structure may be prepared. The melt(s) may be cast-extruded or coextruded into a sheet using a flat die or blown-extruded or coextruded using a tubular die. The sheets may then be oriented either uniaxially or biaxially by known stretching techniques. For example, the sheet may be uniaxially oriented from four to eight times of orientation ratio.

While the films may be made by any method, preferably the films are made by coextrusion and biaxial stretching of the layer(s). The biaxial orientation may be accomplished by either sequential or simultaneous orientation, as is known in the art. In particularly preferred embodiments, the film structure is oriented from four to six times in the machine direction and from four to ten times in the transverse direction.

During the manufacturing process, if the cast temperature is set too low, i.e., quick quenching, the alpha-crystalline form will dominate and the beta-crystalline form will be in the minority. Therefore, films according to the invention are preferably manufactured by setting the cast roll temperature at above 85° C., more preferably from 90° C. to 100° C. The nip roll against the cast roll is preferably set to a range of from 93° C. to 120° C. At these settings, beta-crystalline formation is maximized. Though the films can be cast with or without a waterbath, preferably the film is cast without a waterbath.

In comparison to single component cavitated films, the two-component cavitated films of the invention have a low density of from 0.20 to 0.45 g/cm³, preferably from 0.25 to 0.45 g/cm³, more preferably from 0.25 to 0.40 g/cm³.

The film density values reported herein were measured by a method of first measuring the yield of the film. Specifically, 80 pieces of film from a film sample are cut, each having a diameter of 4 inches (10.16 cm). The total area of the 80 pieces is then calculated. The weight of the 80 pieces (in grams) is then measured. The yield of the film (cm²/gram) will equal the total specimen area (cm²) over the specimen weight (gram).

After measuring the film yield, the film thickness is measured with a laser beam. In particular, the film thickness (mil) is measured with a Model 238-20, available from Beta LaserMike Company. The thickness unit value is converted from mils to centimeters. This non-contact method for measuring film thickness is especially suited for microvoided film because it avoids the error that arises from mechanical compression on the film from a conventional micrometer.

Finally, the density (gram/cm³) is calculated from the inverse (1/X) of the film yield (cm²/gram) times the film thickness (cm).

The two-component cavitated films of the invention have more uniform opacity in comparison to single-component cavitated films. Preferably, the light transmission of the film, as measured by ASTM D1003, is less than 35%, more preferably less than 30%, and most preferably less than 25%.

Films according to the invention are ideal for label applications, including cut & stack labeling, patch, pressure-sensitive adhesive, and in-mold labeling. Their excellent stiffness allows them to endure any labeling and bottling application.

For example, the permeable films of the invention can be used as a label facestock laminated to a silicone release liner with pressure-sensitive adhesive. The pressure-sensitive label stock can be run through a die-cutter to produce labels affixed to a continuous release liner. As another example, the permeable films can be used as cut & stack labels to replace paper-based labels. Traditional cut & stack labels are paper labels coated with cold glue and applied on glass or plastic containers.

The permeable films of the invention may also be used with particular advantage for the manufacture of opaque packages for various materials, such as light-sensitive foodstuffs, particularly where moisture permeability is desired. Additionally, the permeable films may be used for other packaging purposes where opaque polymeric films are required. In general, the films of the invention can be useful for any thick film application that requires superior stiffness.

Due to the high gas and moisture transmission rates of the film structures, they may be used for medical applications, where breathable films are required. Indeed, any development using a water-activated coating would take particular advantage of the breathable permeable films of the invention. Other opportunities are wall paper, high speed water-based ink printing or water-based coatings, water-vapor and gas permeable films for TYVEK's home wrap, stucco wrap, and commercial wrap, a moisture-permeable film for bakery packaging, and air- and moisture-permeable films for garments.

Total thickness of a film according to the invention is not particularly limited. For certain applications, the overall thickness should be greater than 20 μm for poly-gauge. Preferably, the film has an overall thickness of 30 μm to 110 μm for poly-gauge. Preferably, the thickness of each layer, as measured for the poly-gauge, ranges from 15 μm to 80 μm for the core layer; from 0.5 μm to 5 μm for the first outer layer (if present); from 0.5 μm to 5 μm for the second outer layer (if present); and from 1 μm to 10 μm for an intermediate layer (if present).

The present invention will be further described with reference to the following nonlimiting examples. For each example, the thickness values represent poly-gauge thickness.

### EXAMPLES

Test Procedures

Gas permeability results for the example films of the invention are set forth below in terms of Gurley air permeability (s/10 cc). Gurley air permeability was calculated by using a Teleyn Gurley Model 4190 Porosity Tester with sensitivity attachment in accordance with the following procedure:
(a) a strip of film (˜2″ wide) was cut across the entire web width;
(b) the film sample to be tested was inserted between the orifice plates;
(c) the sensitivity adjustment was set to “5;”
(d) the inner cylinder was turned so that the timer eye was vertically centered below the 10 cc silver step on the cylinder;
(e) the timer was reset to zero; and
(f) the spring was pulled clear of the top flange and the cylinder was released.
   When the timer stopped counting, the test was completed. The resulting value was “Gurley seconds per 10 cc.”

Moisture barrier properties were evaluated by determining the water vapor transmission rate (WVTR) of the films according to ASTM F1249 methods.

### Example 1

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 65 wt % PP4612E2 + 25 wt % Bepol |
| | 022SP + 10 wt % HDPE/CaCO₃ |
| | masterbatch (60 wt % CaCO₃ |
| | concentration); 37.5 μm |
| Second layer | TI4040G; 2.5 μm |

The film of Example 1 had a light transmission of about 7.1% and a film density of about 0.358 g/cm³.

### Example 2

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 75 wt % PP4612E2 + 15 wt % Bepol |
| | 022SP + 10 wt % PP/CaCO₃ |
| | masterbatch (70 wt % CaCO₃ |
| | concentration); 37.5 μm |
| Second layer | TI4040G; 2.5 μm |

The film of Example 2 had a light transmission of about 7.5% and a film density of about 0.362 g/cm³.

### Example 3

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 55 wt % PP4612E2 + 25 wt % Bepol |
| | 022SP + 20 wt % PP/CaCO₃ |
| | masterbatch (70 wt % CaCO₃ |
| | concentration); 40 μm |
| Second layer | TI4040G; 2.5 μm |

The film of Example 3 had a light transmission of about 5.4% and a film density of about 0.304 g/cm³.

### Example 4

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 45 wt % PP4612E2 + 25 wt % Bepol |
| | 022SP + 30 wt % PP/CaCO₃ |
| | masterbatch (70 wt % CaCO₃ |
| | concentration); 45 μm |
| Second layer | TI4040G; 2.5 μm |

The film of Example 4 had a light transmission of about 4.3% and a film density of about 0.270 g/cm³.

### Comparative Example A

A three layer opaque film is cast, with waterbath, at 38° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 85 wt % PP4612E2 + 15 wt % |
| | HDPE/CaCO₃ masterbatch (60 wt % |
| | CaCO₃ concentration); 37.5 μm |
| Second layer | TI4040G; 2.5 μm |

The film of this comparative example had a light transmission of about 21.0% and a film density of about 0.555 g/cm³. Conventional polypropylene (without a beta-nucleating additive) is typically cast at around 38° C. with a waterbath in order to facilitate orientation.

### Comparative Example B

A three layer opaque film is cast, without waterbath, at 93° C. and oriented via tenter-frame sequential orientation at five times in the MD and eight times in the TD. The film had an A/B/A structure, as follows:

| | |
|---|---|
| First outer layer | XOM 4712; 2.5 μm |
| Core layer | 85 wt % PP4612E2 + 15 wt % Bepol |
| | 022SP; 32 μm |
| Second layer | XOM 4712; 2.5 μm |

Thus, the core layer of this comparative film had beta-nucleating agent but no filler, e.g., no CaCO₃. This comparative film had a light transmission of about 16.7% and a film density of about 0.56 g/cm³.

### Example 5

A three layer opaque film is cast, without waterbath, at 93° C. and oriented via tenter-frame sequential orientation at five times in the MD and eight times in the TD. The film had an A/B/C structure, as follows:

| | |
|---|---|
| First outer layer | XPM7510; 2.5 μm |
| Core layer | 50 wt % PP4612E2 + 20 wt % Bepol |
| | 022SP + 30 wt % PP/CaCO₃ |
| | masterbatch (70 wt % CaCO₃ |
| | concentration); 42 μm |
| Second layer | XOM 4712; 2.5 μm |

XOM 4712 is a propylene homopolymer, available from ExxonMobil Chemicals.

The film of Example 5 had a film density of about 0.280 g/cm³.

The film was used as a label facestock by laminating it to a release liner with a water-based pressure-sensitive adhesive. In particular, the second outer layer was coated with the pressure-sensitive adhesive, which contacted the silicone surface of the release liner after lamination. The laminated label stock was run through a label-converting machine to make labels.

### Example 6

A cold glue coating, Henkel 7302, was applied to the film from Example 1, and the film with cold glue thereon was applied onto a beer bottle. The Henkel 7302 cold glue coating was applied on the outside surface of the second outer layer.

### Example 7

The outer surface of the second layer of the film of Example 2 was vacuum-metallized with aluminum and used as a metallized-paper replacement.

### Example 8

The outer surfaces of the first and second layers of the film of Example 4 were coated with a coating comprising clay particles dispersed in an iminated butyl acrylate copolymer at a coating weight of 2.6 g/m². The coated film was converted into cut-and-stack labels with a guillotine machine.

### Example 9

A three layer opaque film was cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 73 wt % PP4612E2 + 15 wt % Bepol |
| | 022SP + 12 wt % PP/CaCO₃ |
| | masterbatch (70 wt % CaCO₃ |
| | concentration); 37.5 μm |
| Second outer layer | TI4040G; 2.5 μm |

The film of Example 1 had a Gurley air permeability of 1,875 s/10 cc and a WVTR of 617 g/m² day.

### Example 10

A three layer opaque film was cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 65 wt % PP4612E2 + 15 wt % Bepol |
| | 022SP + 20 wt % PP/CaCO₃ |
| | masterbatch (70 wt % CaCO₃ |
| | concentration); 40 μm |
| Second outer layer | TI4040G; 2.5 μm |

The film of Example 2 had a Gurley air permeability of 1,055 s/10 cc and a WVTR of 876 g/m²/day.

### Example 11

A three layer opaque film was cast, without waterbath, at 93° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 55 wt % PP4612E2 + 15 wt % Bepol |
| | 022SP + 30 wt % PP/CaCO₃ |
| | masterbatch (70 wt % CaCO₃ |
| | concentration); 40 μm |
| Second outer layer | TI4040G; 2.5 μm |

The film of Example 3 had a Gurley air permeability of 343 s/10 cc and a WVTR of 3,054 g/m²/day.

### Comparative Example C

A three layer opaque film was cast, with waterbath, at 38° C. and oriented via tenter-frame sequential orientation at five times in the MD and eight times in the TD. The film had an A/B/A structure, as follows:

| | |
|---|---|
| First outer layer | TI4040G; 2.5 μm |
| Core layer | 85 wt % PP4612E2 + 15 wt % |
| | HDPE/CaCO₃ masterbatch (60 wt % |
| | CaCO₃ concentration); 37.5 μm |
| Second outer layer | TI4040G; 2.5 μm |

The film of this comparative example had a Gurley air permeability of >18 hours/2.5 cc and a WVTR of 5.4 g/m²/day. Conventional polypropylene (without a beta-nucleating additive) is typically cast at around 38° C. with a waterbath in order to facilitate orientation.

While the invention has been described in detail and with reference to specific embodiments thereof, it will be apparent to one of ordinary skill in the art that various changes and modifications can be made therein without departing from the spirit and scope of the invention. The Examples recited herein are demonstrative only and are not meant to be limiting.

What is claimed is:

1. A film structure that is permeable to both gas and water vapor, comprising:
a core layer comprising a propylene polymer, a beta-nucleating agent, and a filler;
a first skin layer on a first side of the core layer, the first skin layer comprising a thermoplastic polymer; and
a second skin layer on a second side of the core layer, the second skin layer comprising a thermoplastic polymer;
wherein the film structure is opaque; and
wherein the film structure has a water vapor transmission rate greater than 300 g/m²/day and a Gurley air permeability less than 3,000 s/10 cc.

2. The film structure of claim 1, wherein the propylene polymer of the core layer is selected from the group consisting of isotactic propylene homopolymer, isotactic propylene impact copolymer, isotactic propylene heterophasic copolymer, and mixtures thereof.

3. The film structure of claim 2, wherein the propylene polymer of the core layer is an isotactic propylene homopolymer having an m-pentad fraction of from 85% to 99%, as measured by ¹³C NMR spectroscopy.

4. The film structure of claim 1, wherein the propylene polymer of the core layer is a mixture of at least two isotactic propylene homopolymers having different m-pentad fractions.

5. The film structure of claim 1, wherein at least one of the thermoplastic polymer of the first skin layer and the thermoplastic polymer of the second skin layer is a polyolefin.

6. The film structure of claim 5, wherein the thermoplastic polymer of the first skin layer is a polyolefin, and the thermoplastic polymer of the second skin layer is a polyolefin.

7. The film structure of claim 1, wherein at least one of the first and second skin layers is a cavitated layer.

8. The film structure of claim 7, wherein each layer of the film structure is a cavitated layer.

9. The film structure of claim 7, wherein the thermoplastic polymer of the first skin layer is a propylene polymer, the propylene polymer of the first skin layer is selected from the group consisting of isotactic propylene homopolymer, syndiotactic propylene polymer, isotactic propylene impact copolymer, isotactic propylene copolymer, and mixtures thereof, and the first skin layer is a cavitated layer comprising a cavitating agent selected from the group consisting of a beta-nucleating agent, a filler, and a mixture thereof.

10. The film structure of claim 9, wherein the cavitating agent of the cavitated first skin layer comprises a beta-nucleating agent.

11. The film structure of claim 9, wherein the cavitating agent of the cavitated first skin layer comprises a filler.

12. The film structure of claim 9, wherein the cavitating agent of the cavitated first skin layer comprises a beta-nucleating agent and a filler.

13. The film structure of claim 9, wherein the thermoplastic polymer of the second skin layer is a propylene polymer, the propylene polymer of the second skin layer is selected from the group consisting of isotactic propylene homopolymer, syndiotactic propylene polymer, isotactic propylene impact copolymer, isotactic propylene copolymer, and mixtures thereof, and the second skin layer is a cavitated layer comprising a cavitating agent selected from the group consisting of a beta-nucleating agent, a filler, and a mixture thereof.

14. The film structure of claim 13, wherein the cavitating agent of the cavitated second skin layer comprises a beta-nucleating agent.

15. The film structure of claim 13, wherein the cavitating agent of the cavitated second skin layer comprises a filler.

16. The film structure of claim 13, wherein the cavitating agent of the cavitated second skin layer comprises a beta-nucleating agent and a filler.

17. The film structure of claim 1, wherein at least one of the first and second skin layers is a microperforated or embossed cavitated layer.

18. The film structure of claim 1, further comprising one or more intermediate layers between the core layer and first skin layer.

19. The film structure of claim 18, further comprising one or more intermediate layers between the core layer and second skin layer.

20. The film structure of claim 19, wherein at least one of (i) an intermediate layer between the core layer and first skin layer and (ii) an intermediate layer between the core layer and second skin layer is a cavitated layer.

21. The film structure of claim 20, wherein (i) and (ii) are both cavitated layers.

22. The film structure of claim 20, wherein each layer of the film structure is a cavitated layer.

23. The film structure of claim 20, wherein intermediate layer (i) comprises a propylene polymer, the propylene polymer of intermediate layer (i) is selected from the group consisting of isotactic propylene homopolymer, syndiotactic propylene polymer, isotactic propylene impact copolymer, isotactic propylene copolymer, and mixtures thereof, and intermediate layer (i) is a cavitated layer comprising a cavitating agent selected from the group consisting of a beta-nucleating agent, a filler, and a mixture thereof.

24. The film structure of claim 23, wherein the cavitating agent of the cavitated intermediate layer (i) comprises a beta-nucleating agent.

25. The film structure of claim 23, wherein the cavitating agent of the cavitated intermediate layer (i) comprises a filler.

26. The film structure of claim 23, wherein the cavitating agent of the cavitated intermediate layer (i) comprises a beta-nucleating agent and a filler.

27. The film structure of claim 23, wherein intermediate layer (ii) comprises a propylene polymer, the propylene polymer of intermediate layer (ii) is selected from the group consisting of isotactic propylene homopolymer, syndiotactic propylene polymer, isotactic propylene impact copolymer, isotactic propylene copolymer, and mixtures thereof, and intermediate layer (ii) is a cavitated layer comprising a cavitating agent selected from the group consisting of a beta-nucleating agent, a filler, and a mixture thereof.

28. The film structure of claim 27, wherein the cavitating agent of the cavitated intermediate layer (ii) comprises a beta-nucleating agent.

29. The film structure of claim 27, wherein the cavitating agent of the cavitated intermediate layer (ii) comprises a filler.

30. The film structure of claim 27, wherein the cavitating agent of the cavitated intermediate layer (ii) comprises a beta-nucleating agent and a filler.

31. The film structure of claim 1, wherein the outer surface of the second skin layer has been metallized.

32. The film structure of claim 1, wherein the beta-nucleating agent of the core layer is a two-component beta-nucleating agent, the first component of the beta-nucleating agent being selected from the group consisting of pimelic acid, azelaic acid, o-phthalic acid, terephthalic acid, and isophthalic acid, and the second component of the beta-nucleating agent being selected from the group consisting of an oxide, a hydroxide, and an acid salt of a Group II metal.

33. The film structure of claim 1, wherein the filler of the core layer is an inorganic filler selected from the group consisting of CaCO₃, BaCO₃, clay, talc, silica, mica, TiO₂, and mixtures thereof.

34. The film structure of claim 1, wherein the core layer comprises from 1 wt % to 50 wt % of the filler, based on the total weight of the core layer.

35. The film structure of claim 1, wherein the core layer comprises from 50 ppm to 1,000 ppm of the beta-nucleating agent, based on the amount of propylene polymer in the core layer.

36. The film structure of claim 1, wherein the film structure is a biaxially oriented film structure.

37. The film structure of claim 1, wherein the film structure consists of the core layer, the first skin layer, and the second skin layer, the film structure optionally has a coating on at least one of its outer surfaces, and the film structure optionally has been metallized on the outer surface of the second skin layer.

38. The film structure of claim 37, wherein each layer of the film structure is a cavitated layer.

39. The film structure of claim 1, wherein the film structure consists of the core layer, the first skin layer, the second skin layer, a first intermediate layer between the core layer and the first skin layer, and a second intermediate layer between the core layer and the second skin layer, and the film structure optionally has a coating on at least one of its outer surfaces, and the film structure optionally has been metallized on the outer surface of the second skin layer.

40. The film structure of claim 39, wherein each layer of the film structure is a cavitated layer.

41. The film structure of claim 1, wherein at least one outer surface of the film structure has a coating thereon.

42. A container comprising an in-mold label, wherein the in-mold label comprises the film structure of claim 1.

43. The container of claim 42, wherein each layer of the film structure is a cavitated layer.

44. A label, comprising an adhesive on an outer surface of a film structure, wherein the film structure comprises:
a core layer comprising a propylene polymer, a beta-nucleating agent, and a filler;
a first skin layer on a first side of the core layer, the first skin layer comprising a thermoplastic polymer; and
a second skin layer on a second side of the core layer, the second skin layer comprising a thermoplastic polymer;
wherein the film structure is opaque; and
wherein the film structure has a water vapor transmission rate greater than 300 g/m²/day and a Gurley air permeability less than 3,000 s/10 cc.

45. The label of claim 44, wherein the adhesive is a cold glue adhesive.

46. The label of claim 44, wherein the adhesive is a pressure-sensitive adhesive.

47. The label of claim 44, wherein the film structure consists of the core layer, the first skin layer, and the second skin layer, the adhesive is on the outer surface of the first skin layer, and the film structure optionally has been metallized on the outer surface of the second skin layer.

48. The label of claim 47, wherein each layer of the film structure is a cavitated layer.

49. The label of claim 44, wherein the film structure consists of the core layer, the first skin layer, the second skin layer, a first intermediate layer between the core layer and the first skin layer, and a second intermediate layer between the core layer and the second skin layer, the adhesive is on the outer surface of the first skin layer, and the film structure optionally has been metallized on the outer surface of the second skin layer.

50. The label of claim 49, wherein each layer of the film structure is a cavitated layer.
